(19) United States
(12) Patent Application Publication
(10) Pub. No.: US 2009/0143910 A1
(43) Pub. Date: Jun. 4, 2009

(54) INTELLIGENT PRINTING SYSTEM WITH DELIVERY ROBOTS FOR DELIVERING PRINTED DOCUMENTS AND METHOD THEREFOR

(75) Inventors: Beom-Su SEO, Daejeon (KR); Kyeong Ho Lee, Daejeon (KR); Joong Bae Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/326,625

(22) Filed: Dec. 2, 2008

(30) Foreign Application Priority Data
Dec. 3, 2007 (KR) 10-2007-0124159
Apr. 28, 2008 (KR) 10-2008-0039231

(51) Int. Cl. B25J 5/00; B25J 9/00

(52) U.S. Cl. 700/245; 901/1

(57) ABSTRACT

An intelligent printing system includes a printed document delivery robot for delivering printed documents. The robot identifies a location of each user PC requesting for printing based on a network address of the PC and establishes a print plan based on the print request. Upon completion of a printing job, the robot travels along a movement path having the shortest distance to each user PC who has requested for printing.

### CROSS-REFERENCE(S) TO RELATED APPLICATION(S)

The present application claims priority of Korean Patent Applications No. 10-2007-0124159 and 10-2008-0039231, filed on Dec. 3, 2007 and Apr. 28, 2008, which are incorporated herein by reference.

### FIELD OF THE INVENTION

The present invention relates to a network printer system, and more particularly, to an intelligent printing system with a delivery robot and method for serving to deliver printed documents requested by multiple users from the printing system to each user's location upon completion of the printing job.

This work was supported by the IT R&D program of MIC/ITTA [2005-S-033-03, Embedded Component Technology and Standardization for URC].

### BACKGROUND OF THE INVENTION

Typically, a fixed-type shared printer is commonly used through a network by multiple users in a space such as an office. The shared printer is fixedly installed in a specific space of an office and functions to output printed documents requested by multiple users. The user who requested the printing needs to go directly to the location of the printer to get the printed documents.

However, since the above-mentioned fixed-type shared printer merely executes the function of outputting the printed documents requested by a user and sequentially discharging them to a loading unit, the user has to go directly to the location of the printer in order to check whether the printed documents are properly outputted or in order to get the printed documents after sending a print command.

Thus, in an office environment where a fixed-type shared printer is used, there occurs a problem that a user who has requested for printing has to frequently go to the printer to check the outputting or not of a printed document or get the printed document, thereby wasting the working time and disturbing concentration on his or her work.

### SUMMARY OF THE INVENTION

It is, therefore, an object of the present invention to provide an intelligent printing system with a delivery robot and method for delivering printed documents to the location of each user who has requested for the printing upon completion of a printing job.

In accordance with a first aspect of the present invention, there is provided a robot for delivering printed documents in an intelligent printing system, including:

a task plan storing unit for storing location information of each user PC who has requested for printing to the intelligent printing system via a network and information of a movement path to said each user PC;

a driver control unit for controlling the movement of the printed document delivery robot to the location of said each user PC; and

a task processing unit, upon completion of a printing job, for giving a command to the driver control unit to move along the movement path.

In accordance with a second aspect of the present invention, there is provided an intelligent printing system, including:

an information processing unit, upon receipt of a print request from each of user PCs through a network, for calculating location of said each PC and a movement path to said each PC; and

a printed document delivery robot for delivering the printed documents while sequentially moving to said each PC based on the movement path, upon completion of a printing job.

In accordance with a third aspect of the present invention, there is provided a method for delivering printed documents in an intelligent printing system having a printing unit, an information processing unit, and a printed document delivery robot, wherein the method includes:

calculating, in the information processing unit, upon receiving a print request from each of the user PCs via a network, location of said each of the user PCs and a movement path to said each of the user PCs;

executing, in the printing unit, a printing job requested from said each PC; and

delivering, in the delivery robot, printed documents, of which printing job is completed, to the respective user PCs along the calculated movement path.

### BRIEF DESCRIPTION OF THE DRAWINGS

The above and other objects and features of the present invention will become apparent from the following description of preferred embodiments, given in conjunction with the accompanying drawings, in which:

FIG. 1 shows a configuration of an intelligent printing system in accordance with an embodiment of the present invention;

FIG. 2 illustrates a detailed block diagram of the information processing unit shown in FIG. 1;

FIG. 3 presents a detailed block diagram of the printed document delivery robot shown in FIG. 1;

FIG. 4 illustrates a control flow diagram of a printing operation in accordance with the embodiment of the present invention; and

FIG. 5 describes a control flow diagram of a printed document delivery operation in accordance with the embodiment of the present invention.

### DETAILED DESCRIPTION OF THE EMBODIMENTS

Hereinafter, the operational principle of the present invention will be described in detail with reference to the accompanying drawings. In the following description, well-known functions or constitutions will not be described in detail if they would obscure the invention in unnecessary detail. Also, the terminologies to be described below are defined in consideration with functions in the present invention and may vary depending on a user's or operator's intention or practice. Thus, the definitions should be understood based on all the contents of the specification.

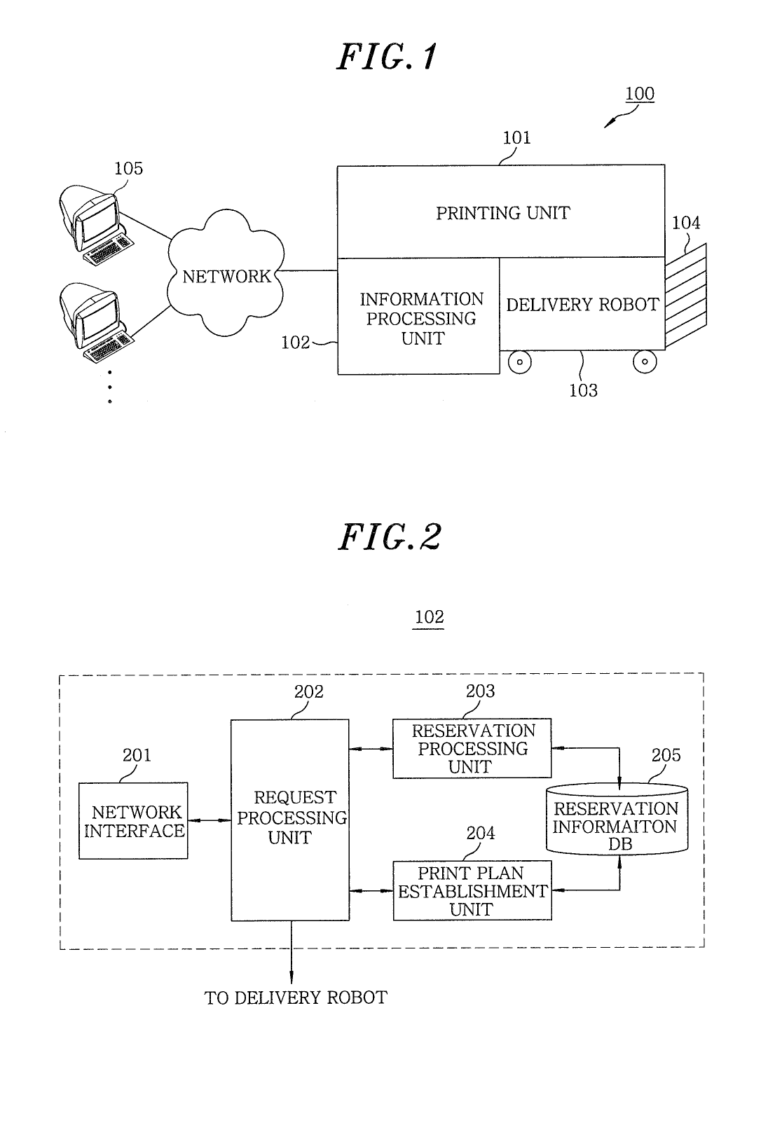

FIG. 1 illustrates the configuration of an intelligent printing system which is implemented to deliver printed documents after completion of a printing job in accordance with an embodiment of the present invention. The intelligent printing system 100 includes a printing unit 101, an information processing unit 102, and one or more printed document delivery robots 103.

The intelligent printing system is connected via a network to user PCs. Each of the user PCs transmits a print request, including an immediate print request and a reserved print request, to the information processing unit 102. Unlike the immediate print request, the reserved print request refers to making a print request by specifying, not a current time point at which a printing request is made, but a desired specific time point, corresponding to a printing time point of a document that the user wants to print through the printer 100.

The printing unit 101 is a device equipped with a toner, a print head, etc., which executes a printing job following a print command through the information processing unit 102 and then discharges printed documents, of which printing is completed, to the loading unit 104 installed at the delivery robot 103.

Upon receipt of a print request from the plurality of user PCs, the information processing unit 102 sends a print job command to the printing unit 101, and calculates location of each user PC and movement paths to all the user PCs and sends a command to deliver the printed documents to each user PC.

The delivery robot 103 receives the location information and movement path information of each user PC from the information processing unit 102, and delivers the printed documents from the printing unit 101 to a target position upon completion of the printing job while sequentially moving to each user PC based on the movement path information.

FIG. 2 illustrates a detailed block diagram of the information processing unit 102 depicted in FIG. 1. The information processing unit 102 includes a network interface 201, a request processing unit 202, a reservation processing unit 203, a print plan establishment unit 204, and a reservation information database (DB) 205.

First, the network interface 201 receives a print request from a user PC connected via a network, for example, a LAN, and sends it to the request processing unit 202. The request processing unit 202 receives the print request from the user PC through the network interface 201 and sends a printing job instruction to the printing unit 101 in accordance with the print request, and gives a command to the printed document delivery robot 103 to deliver the printed documents.

The reservation processing unit 203 processes a reserved print request, among the print requests from the user PCs that are received by the request processing unit 202, serves to store it in the reservation information DB 205, and periodically searches the reservation information DB 205 to check if there is any reserved print request that has reached a reserved printing time point.

The print plan establishment unit 204 establishes the whole print plan based on an immediate print request from the user PCs received by the request processing unit 202 and the reserved print request stored in the reservation information DB 205. In addition, print plan establishment unit 204 extracts the location information of each user PC that has requested for printing through the network, calculates an optimum movement path having the shortest moving distance from the location of the intelligent printing system to the location of each user PC based on the extracted location information of each user PC, and then the same to the request processing unit 202.

For judging the location of a user PC, a network address, e.g., a media access control (MAC) address or IP address may be used, and for storing the location information of a user PC and the MAC address or IP address, a database or a file system may be employed. Further, for judging the physical location of a user PC, an environment mapping technique, which is generally used in the field of robots, may be employed. If this technique is based on a MAC address, it is supported by a dedicated printing program of the user PC.

Also, in calculating the optimum movement path, a previously calculated movement path is stored in the reservation information DB 205, and thereafter the previously calculated movement path is read for use in the event of delivery of printed documents to the same user PCs, so that the calculation time of the movement path can be reduced.

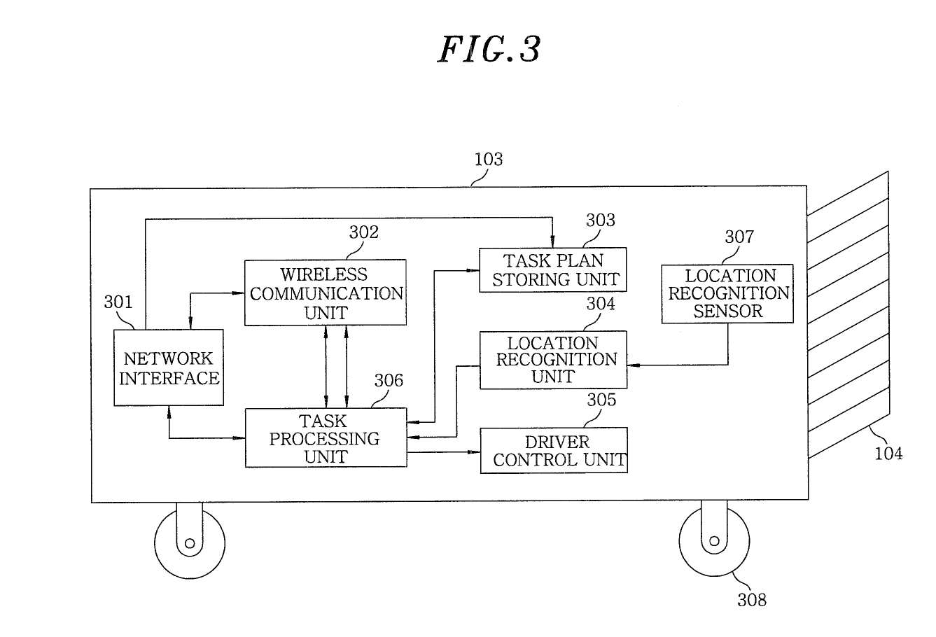

FIG. 3 illustrates a detailed block diagram of the delivery robot 103 shown in FIG. 1. The delivery robot 103 includes a moving unit 308, such as wheels, a network interface 301, a wireless communication unit 302, a task processing unit 306, a task plan storing unit 303, a location recognition unit 304, a driver control unit 305 and a location sensor 307.

The network interface 301 serves to connect the delivery robot 103 to the network. The network interface 301 receives location information of each user PC and information about an optimum movement path to the location of each user PC from the request processing unit 202 within the information processing unit 102, and provides them to the task plan storing unit 303.

The loading unit 104 loads printed documents thereon, of which printing is completed, from the printing unit 101. The wireless communication unit 302 sends/receives a message about the delivery and receipt of printed documents to/from each user PC through the network interface 301 in a wired and/or wireless manner The task plan storing unit 303 stores the location information of each user PC and the information about an optimum movement path to each user PC, which are received through the network interface 301.

If there is a move command for delivering the printed documents from the task processing unit 306, the driver control unit 305 controls the movement of the delivery robot 103 to the location of each user PC traveling along the movement path information by driving the moving unit 308, such as wheels.

Upon delivery of the printed documents, the task processing unit 306 gives a command to the driver control unit 305 to move for delivering the printed documents, continuously detects the location of the printed document delivery robot 103 traveling along the movement path, and provides feedback to the driver control unit 305 to modify the movement path if necessary. The location of the delivery robot 103 is detected by the location sensor 307 arranged in association with the moving unit 308, which may be located at the lower end of the delivery robot 103. The location sensor 307 may include an encoder, a detailed description of which will be omitted here. In addition, the task processing unit 306 sends a printed document delivery message to the corresponding user PC through the wireless communication unit 302 upon arrival at the location of the corresponding user PC by following the above movement path. When receiving a printed document receipt message from the corresponding user PC in response to the printed document delivery message, the task processing unit 306 allows executing the delivery of the printed documents. To be more specific, the task processing unit 306 sends/receives the printed document delivery or receipt message to/from each user PC by using IP address information of the user PC. The printed document delivery message as above can be displayed in a text message form on the screen of the user PC, which can be implemented by a printing-related program installed in the user PC to support the corresponding function.

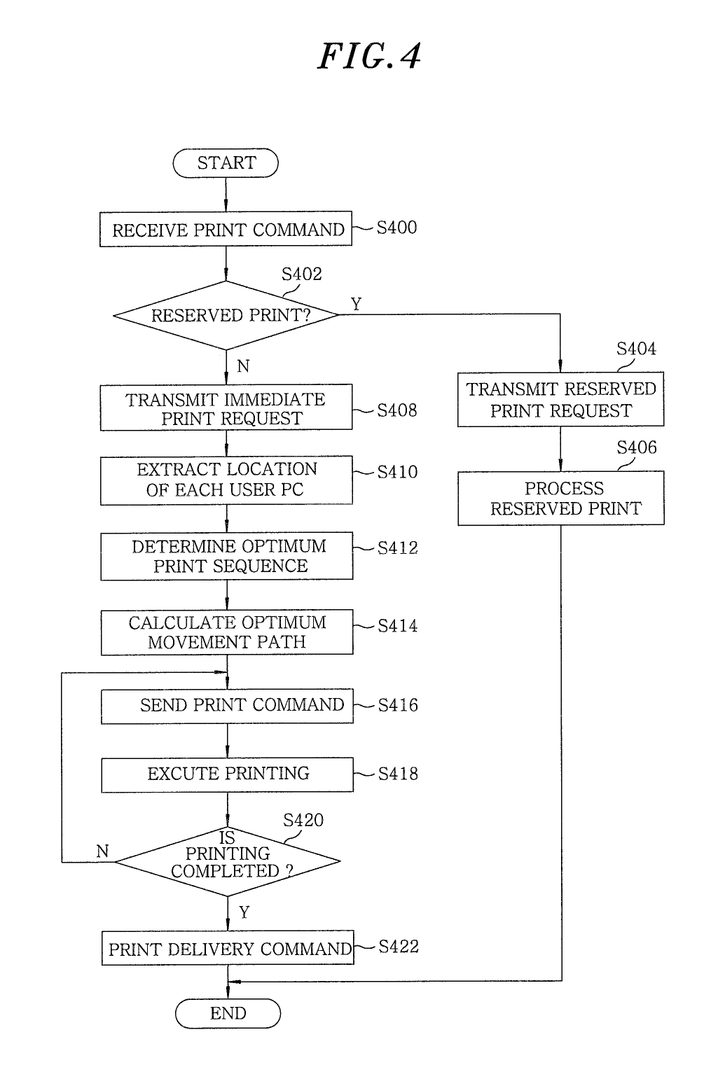

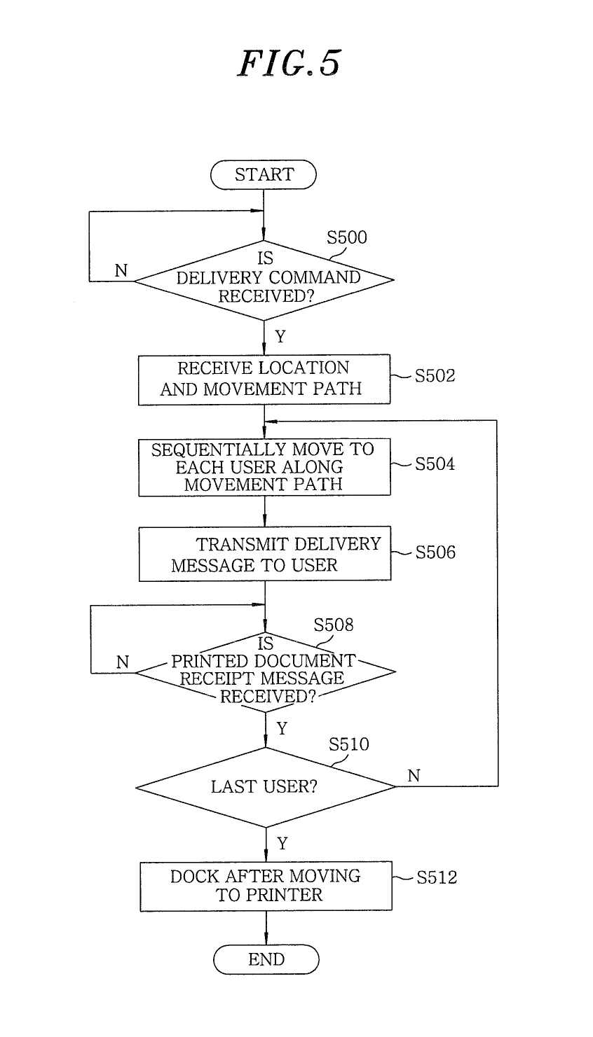

FIG. 4 illustrates a control flow diagram in which the intelligent printing system processes a print request sent from each user PC in accordance with the embodiment of the present invention. Hereinafter, the embodiment of the present invention will be described in further detail with reference to FIGS. 2 and 4.

First, users located in an office space where the intelligent printing system 100 is disposed send a request to the intelligent printing system 100 to print documents prepared in their PCs. Then, the print request is provided to the intelligent printing system 100 through the network.

Then, in step S400, the request processing unit 202 in the information processing unit 102 receives the print request from the user PC through the network interface 201. Next, in step S402, it is checked whether the above print request is an immediate print request or a reserved print request. If the print request is a reserved print request, the request processing unit 202 proceeds to step S404 to apply the reserved print request to the reservation processing unit 203. Then, in step S406, the reservation processing unit 203 stores a time of the reserved print request in the reservation information DB 205, and thereafter periodically searches the reservation information DB 205 to judge whether there is any reserved print request to be put into print. If there is any reserved print request to be executed, reservation processing unit 203 transmits the corresponding print information to the print plan establishment unit 204.

However, in step S402, if the print request from the user PC is an immediate print request, the request processing unit 202 proceeds to step S408 to immediately transmit the immediate print request to the print plan establishment unit 204. Then, in step S410, the print plan establishment unit 204 identifies the location of the user PC based on a MAC address or IP address for the user PC who has requested for printing.

If the location of the user PC is identified as above, the print plan establishment unit 204 goes to step S412 that determines an optimum print sequence in consideration of the location of the user PC. At this time, a method for determining the optimum print sequence involves positioning the printed document of the nearest user at the uppermost end of the loading unit 104 by outputting a request from the nearest user in the last place.

Next, in step S414, the print plan establishment unit 204 calculates an optimum movement path from the location of the intelligent printing system 100 to the location of each user PC based on the location information of each user PC and the print sequence in order to deliver the printed documents.

Thereafter, in step S416, the print plan establishment unit 204 sends a print command to the request processing unit 202. At this time, when sending the print command to the request processing unit 202, the print plan establishment unit 204 sends the optimum movement path information calculated as above for the delivery of the printed documents, the print sequence, and the location information of the user PC to the delivery robot 103 through the request processing unit 202 so that the delivery robot 103 can utilize these information upon delivery of the printed documents. As for the optimum movement path information, if the same user PC is involved, the previously stored optimum movement path information can be retrieved from the database.

As stated above, if the print command is sent from the print plan establishment unit 204, the request processing unit 202 gives a command to the printing unit 101 to execute printing in step S418. In response to the command, the printing unit 101 executes a requested printing in accordance with the print sequence.

Next, in step S420, the request processing unit 202 checks whether or not the requested printing job is completed in the intelligent printing system 100. If the printing job is completed, in step S422, the request processing unit 202 gives a command to the delivery robot 103 to deliver the printed documents to the respective user PCs. Further, the request processing unit 202 provides information on the location of each user PC and the optimum movement path to the printed document delivery robot 103 so that the delivery robot 103 can move to the location of the user PC along the optimum movement path.

FIG. 5 illustrates a control flow diagram in which a printed document of which printing job is completed is delivered to its corresponding user PC in accordance with the present invention. This will now be described in detail with reference to FIGS. 2, 3, and 5.

First, when a printing job is completed, a printed document delivery command is sent from the request processing unit 202 in the information processing unit 102 to the delivery robot 103. At this time, information on the location of the user PC to which the printed document is to be delivered and optimum movement path are provided, and these information are stored in the task plan storing unit 303 in the printed document delivery robot 103.

Then, in step S500, the task processing unit 306 of the delivery robot 103 receives the printed document delivery command from the request processing unit 202, and, in response to this command, in step S502, the task processing unit 306 identifies the information on the location of the user PC to which the printed document is to be delivered and the optimum movement path which are stored in the task plan storing unit 303.

Next, in step S504, the task processing unit 306 delivers the printed document to the corresponding user PC while moving along the optimum movement path in accordance with a printed document delivery sequence. In this regard, for the actual movement of the delivery robot 103, the task processing unit 306 applies a driving command to the driver control unit 305 so as to enable the delivery robot 103 to move along the optimum movement path. Then, the driver control unit 305 drives the moving unit 308 of the delivery robot 103. The task processing unit 306 continuously traces the current position of the robot 103 by means of the location sensor 307 and the location recognition unit 304 and provides feedback to the driver control unit 305, so that the delivery robot 103 traveling along the movement path can follow the movement path more accurately.

In this way, when the printed document arrives at the location of each user PC to which the printed document is to be delivered as it moves along the optimum movement path, the task processing unit 306 sends a message notifying the corresponding user PC that the printed document has been delivered by using IP address of the user PC in step S506. Thus, the user of the corresponding PC confirms the delivery of the printed document through the above message and receives the printed document, and, upon normal receipt of the printed document, sends a printed document delivery confirmation message in response to the above printed document delivery message.

Subsequently, in step S508, the task processing unit 306 checks whether the printed document delivery confirmation message is received from the user PC after the receipt of the printed documents, and if the printed document delivery confirmation message is normally received from the corresponding user PC through the wireless communication unit 302, the delivery routine moves to another user PC requiring the next delivery of a printed document. That is to say, if the printed document delivery message is normally received, a control process proceeds to step S510 where the task processing unit 306 checks whether there exists further user PC requiring the delivery of a printed document. If there is any remaining user PC, the steps S504 to S508 are repeated to deliver the printed document.

However, if there exists no other user PC requiring the delivery of a printed document any longer, the task processing unit 306 judges that the printed document delivery job is completed, and then a control process proceeds to step S512 to move the delivery robot 103 to the intelligent printing system 100 through the driver control unit 305. As a result, the delivery robot 103 returns to the intelligent printing system 100, and is docked to the intelligent printing 100 or, if there is any other delivery robots already docked thereto, waits for docking.

As described above, the present invention achieves to minimize the moving distance of users using an intelligent printing system by implementing one or more printed document delivery robots capable of delivering printed documents to the locations of a plurality of user PCs in the intelligent printing system arranged in a fixed type, and then implementing the printed document delivery robots to automatically delivery the printed documents upon completion of a printing job by using the location information of the user PCs and the optimum movement path information to each user PC from the intelligent printing system. Furthermore, the present invention may increase working efficiency by enabling the users to execute a reserved printing which can print and delivery a given document at a specified time.

While the invention has been shown and described with respect to the preferred embodiments, it will be understood by those skilled in the art that various changes and modification may be made without departing from the scope of the invention as defined in the following claims.

What is claimed is:

1. A robot for delivering printed documents in an intelligent printing system, comprising:
a task plan storing unit for storing location information of each user PC who has requested for printing to the intelligent printing system via a network and information of a movement path to said each user PC;
a driver control unit for controlling the movement of the printed document delivery robot to the location of said each user PC; and
a task processing unit, upon completion of a printing job, for giving a command to the driver control unit to move along the movement path.

2. The robot for delivering printed documents of claim 1, further comprising a network interface for receiving the location information of said each user PC and the movement path information and applying the received information to the task plan storing unit.

3. The robot for delivering printed documents of claim 1, further comprising a printed document loading unit for loading printed documents of which printing job has been completed.

4. The robot for delivering printed documents of claim 1, further comprising a wireless communication unit for sending/receiving wireless messages about the delivery and receipt of the printed documents to/from said each user PC.

5. The robot for delivering printed documents of claim 1, wherein the task processing unit continuously traces the location of the printed document delivery robot traveling along the movement path, and provides feedback to the driver control unit.

6. The robot for delivering printed documents of claim 4, wherein the task processing unit sends a printed document delivery message to said each user PC through the wireless communication unit upon arrival at the location of said each user PC by movement, and receives a printed document receipt message from said each user PC to execute the delivery of the printed documents.

7. The robot for delivering printed documents of claim 6, wherein the task processing unit sends/receives the printed document delivery or receipt message to/from said each user PC by using network address of said each user PC.

8. An intelligent printing system, comprising:
an information processing unit, upon receipt of a print request from each of user PCs through a network, for calculating location of said each PC and a movement path to said each PC; and
a printed document delivery robot for delivering the printed documents while sequentially moving to said each PC based on the movement path, upon completion of a printing job.

9. The intelligent printing system of claim 8, further comprising a printing unit for executing the printing job requested from said each PC.

10. The intelligent printing system of claim 9, wherein the information processing unit includes:
a request processing unit for giving a command to the printing unit to execute the printing job in response to the print request, and giving a command to deliver the printed documents to the printed document delivery robot; and
a print plan establishment unit for establishing the whole print plan upon receipt of the print request, identifying the location of said each of the user PCs, and calculating the movement path having the shortest moving distance to the location of said each PC based on the location of said each PC.

11. The intelligent printing system of claim 10, wherein the print plan establishment unit identifies the location information of said each of the user PCs based on a network address for said each of the user PCs.

12. The network printer of claim 10, wherein a movement path previously identified by the print plan establishment unit is retrieved for use in the event of delivery of printed documents to the same user PCs.

13. The intelligent printing system of claim 10, wherein the print request includes a reserved print request and an immediate print request, and
wherein the information processing unit further includes:
a reserved processing unit for processing the reserved print request; and
a reservation information database for storing the results of the reserved print request processed by the reserved processing unit.

14. The intelligent printing system of claim 13, wherein the whole print plan is established based on the immediate print request and the result of the reserved print request stored in the reservation information database.

15. The intelligent printing system of claim 10, wherein the information processing unit further includes a network interface for receiving the print request and sending the same to the request processing unit.

16. A method for delivering printed documents in an intelligent printing system having a printing unit, an information processing unit, and a printed document delivery robot, wherein the method comprises:
calculating, in the information processing unit, upon receiving a print request from each of the user PCs via a network, location of said each of the user PCs and a movement path to said each of the user PCs;
executing, in the printing unit, a printing job requested from said each PC; and
delivering, in the delivery robot, printed documents, of which printing job is completed, to the respective user PCs along the calculated movement path.

17. The method of claim 16, wherein calculating the location and the movement path includes:
establishing a print plan upon receiving the print request from said each PC;
identifying the location of said each PC that has requested for printing and determining a printing sequence in accordance with the print plan; and
calculating a movement path having the shortest moving distance to said each PC for the delivery of printed documents to said each PC.

18. The method of claim 17, wherein establishing the print plan includes:
receiving the print request including an immediate print request and a reserved print request from said each PC, wherein the print request includes an immediate print request and a reserved print request;
periodically checking a reserved printing time point on the reserved print request; and
establishing the whole print plan based on the immediate print request and the reserved print request that has reached the reserved printing time point.

19. The method of claim 17, wherein the location of said each PC is identified by a network address of said each PC.

20. The method of claim 16, wherein delivering the printed documents includes:
collecting the location information of said each PC and the movement path information for delivering the printed documents upon completion of the printing job;
sequentially moving to the location of said each PC that has requested for printing by following the movement path; and
delivering the printed documents to said each PC that requested for printing upon arrival at the location of said each PC.

21. The method of claim 20, wherein sequentially moving to the location of said each PC includes:
moving to the location of said each PC along the movement path; and
modifying the movement path by providing feedback on and continuously checking the location of the delivery robot traveling along the movement path during movement to the location of said each PC.

22. The method of claim 20, wherein delivering the printed documents further includes:
sending a printed document delivery message upon arrival at the location of said each PC; and
receiving a printed document receipt message from said each PC after the receipt of the printed documents to execute the delivery of the printed documents.
